(19) United States
(12) Patent Application Publication
(10) Pub. No.: US 2002/0135695 A1
(43) Pub. Date: Sep. 26, 2002

(54) Video data reduction by selected frame elimination

(76) Inventors: Steven D. Edelson, Wayland, MA (US); Klaus Diepold, Siegertsbrunn (DE); Siegfried Wonneberger, Munchen (DE)

Correspondence Address: VENABLE, Post Office Box 34385, Washington, DC, 20043-9998, US

(21) Appl. No.: 09/816,117

(22) Filed: Mar. 26, 2001

(51) Int. Cl. H04N 7/12; H04N 11/02; H04N 11/04

(52) U.S. Cl. 348/439.1

(57) ABSTRACT

In a video processing system selected frames are eliminated to reduce the amount of video data. The frames are selected for elimination by scoring the frames to determine which frames can be eliminated and then most easily recreated from the remaining video after the elimination has taken place. When frames are eliminated, residuals are produced representing the difference between the recreated frames and the corresponding original frames which were eliminated. The frame elimination and generation of residuals is carried out in repeated cycles to progressively reduce the size of the remaining video until the amount of data in the computed residuals for each frame in the reduced video equals or exceeds the amount of data in the corresponding frames.

### CROSS REFERENCE TO RELATED APPLICATIONS

This application claims the benefit under 35 U.S.C. 120 of U.S. application Ser. No. 09/617,778 filed Jul. 17, 2000, entitled A Method and Apparatus for Reducing Video Data.

This invention relates to motion picture video data reduction and more particularly to a video data reduction system of a type which eliminates video frames, which are then recreated from the reduced version of the video when the motion picture video is expanded back to its original form or an approximation thereof.

### BACKGROUND OF THE INVENTION

There are several compression techniques currently used for images, cartoon-like animation and video. Images are the easiest to compress and video is the most difficult. Animation yields to techniques in which the objects and their motion are described in transmitted data and the receiving computer animates the scene. Commercial products such as Macromedia Shockwave take advantage of these techniques to deliver animated drawings over the Internet. Video cannot benefit from this technique. In video, the images are captured without knowledge of the content. It is an unsolved problem for a machine to recognize the objects within a captured video and then manipulate them.

To reduce the size of video files for Internet, individual pictures (“frames” ) are removed. This technique is very effective in data reduction, but the removal of frames results in visible gaps in the motion. The illusion of motion disappears and the video motion perceived usually becomes jerky and less pleasant to the viewer.

There are new techniques being developed that mend reduced videos by filling in video gaps with recreated frames. The most sophisticated, such as that disclosed in copending application Ser. No. 09/459,988, filed Dec. 14, 1999, by Steven D. Edelson and Klaus Diepold, use motion estimation to properly estimate the recreated frames to be inserted and do a superior job. Using a tool like that disclosed in application Serial No. 09/459,988 can help restore the damage done by elimination of frames.

Because these mending techniques are estimation techniques, the results vary depending on the content of the source videos. Within a given video, certain frames can be eliminated and restored with little error while others, when removed, do not lend themselves to efficient restoration.

If a system were to know that the receiver had an effective video mending capability, it could make intelligent decisions to eliminate the frames which do the least damage (easiest to mend). Such a system could achieve maximum data reduction with the highest quality reproduction of the motion picture.

### SUMMARY OF THE INVENTION

The system of the present invention examines an input video and evaluates which video frames can be eliminated with the best result. To examine the video, a copy of the mending program is used to generate actual mending results of each frame and compares this result to the original. Each frame is scored on the results of the comparison and the frames in the original video, which correspond to mended frames which most closely duplicate the original frames are removed. This process is repeated until the video is reduced to a point to achieve maximum reduction.

The reduced video is compressed and then transmitted to a receiver or stored in a data storage device. Because the number of video frames have been reduced, the transmission of the reduced video requires much less bandwidth. Also, when the reduced video is stored, it requires much less storage space. To restore the reduced video to a condition to provide a quality motion picture display approximating or equaling that of the original video, a mending video processor recreates the frames which have been eliminated from the reduced video by interpolation as described in the above mentioned co-pending application Ser. No. 9/459,988. To further improve the quality of the restored motion picture, the mended video frames produced at the video reduction processor are compared with the corresponding frames of the original video to generate residuals representing the differences between the original frames and the mended frames. The residuals are used by the mending video processor to recreate the frames which had been eliminated. In this recreation the frames are first recreated by interpolation and then the corresponding residuals are added to the recreated frames. If the compression is lossless, this process can provide a perfect recreation of the original frames so that the quality of the mended motion picture is equal to that of the original motion picture.

The use of residuals in this manner allows the quality of the motion picture to be maintained while permitting a great reduction in the amount of data that must be transmitted or stored. This result is achieved in part because of the nature of the residuals. Since the residuals represent the difference between mended frames and the corresponding original eliminated frames, which were selected for elimination because they most closely resemble the original frames, the residuals will mostly be very low values and also, for the most part, are not subject to variation from pixel to pixel. These characteristics of the residuals mean that the data in the residuals can be effectively compressed to a high degree.

In accordance with the present invention, the video reduction processor continues the process of eliminating frames selected for elimination by the scoring process until the data in the residuals determined for each of the frames remaining in the reduced video equals or exceeds the data in the corresponding frames. When the point of equality is reached, the frame elimination is stopped. The resulting file of data containing the remaining frames of the original video and the calculated residuals will then be reduced by the maximum amount. Accordingly, the bandwidth required to transmit the combined file will be reduced to a minimum and the storage required to store the video file will be reduced by the maximum amount.

### BRIEF DESCRIPTION OF THE DRAWINGS

FIG. 1 is a block diagram grammatically illustrating the system of the invention.

FIG. 2 is a flow chart illustrating the method of video data reduction employed in the system of the present invention.

FIG. 3 is a flow chart illustrating in more detail how motion picture frames are scored in the process illustrated in FIG. 2.

FIG. 4 is a flow chart further illustrating motion picture frame scoring.

### DESCRIPTION OF A PREFERRED EMBODIMENT OF THE INVENTION

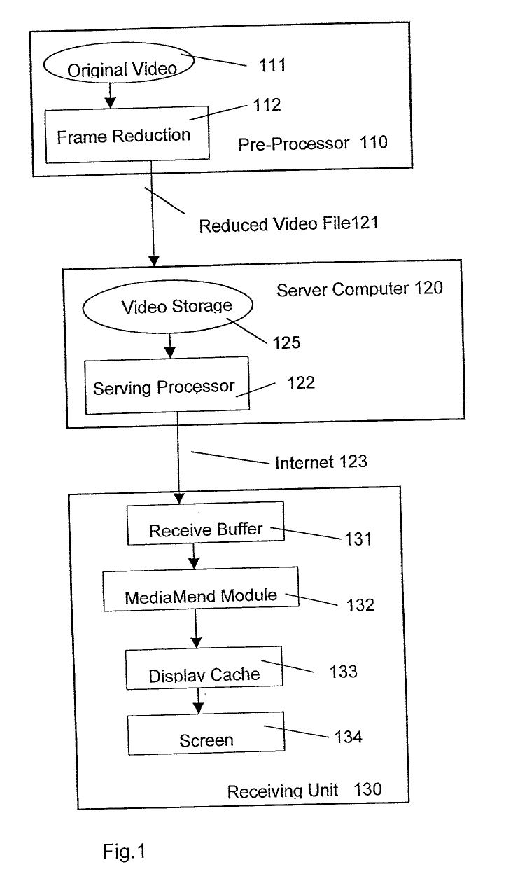

As shown in FIG. 1, the video passes from a preprocessor 110 to the server computer 120 and then over the Internet to the receiving unit 130. The preprocessor 110 functions as the video reduction processor. The receiving unit may be a personal computer comprising the mending processor, but could also be another device such as an Internet-cable-TV box (sometimes called “set-top box”), a web phone or other Internet appliance. Although this process may be spread on more computers or consolidated onto fewer, the preferred embodiment employs three computers as shown in FIG. 1.

In the preprocessor, the original video 111 is passed through the frame reduction process 112. Although it does not interfere with the invention, it should be noted that other processing is also performed in the preprocessor 110, including color adjustment, frame size adjustment and compression using any of a variety of compressors such as MPEG-like discrete cosine transform techniques or wavelets. The output is a reduced video file 121 that is stored in video storage 125 on the video server 120. The video file 121 is reduced by the elimination of frames from the original video. As is explained below, the eliminated frames will be reproduced at the receiver by an interpolation or other process. The reduced file created by the preprocessor will also include residuals, which are calculated by reproducing the eliminated frames at the preprocessor by the same process that they will be recreated at the receiver. These recreated frames are compared with the corresponding original frames and the differences are the residuals which are included in a reduced combined file. A serving processor 122 in the server computer 120 is connected to the Internet 123 (or other distribution means) to serve the combined file of the reduced video and the residuals to client machines on the Internet after the combined file has been compressed.

The combined file, when received in the receiving unit 130, is stored in a receive buffer 131. In the proper schedule sequence, the video is decompressed and moved to the display cache 133 from which the video can be displayed on screen 134. On the way to the display cache, the video is passed through a mending module 132 which recreates and inserts the missing frames in the reduced video to produce a mended version of the original video. This mending module generates the missing frames by interpolation such as by the method described in above mentioned U.S. application Ser. No. 09/459,988, which is hereby incorporated by reference. Alternatively, another equivalent process could be used. The mending module then adds the residuals to the frames created by interpolation, to make a reproduction of the originals. The reproduction may be an exact copy if the compression is lossless and an exact set of complete residuals is transmitted to the receiving unit. Alternatively, at the option of the user, an exact complete set of the residuals may not be transmitted, or the residuals may be transmitted with compression that is inexact. The resulting copy can still be of high quality but not be an exact copy. The mending module 132 also has the ability to pass through the video without changing the video, if so requested. This selection of the mode of operation to pass through the video without change may be made for the whole video or on a scene-by-scene or even on frame-by-frame basis.

Residuals can also be used to convert a lossy compression of video frames of the reduced video to a lossless compression. To achieve this conversion, the frames are compressed and then decompressed and then compared with the original frames to produce residuals. If the residuals are compressed by a lossless compression and transmitted or saved with the compressed frames, the residuals can be added to the decompressed frames to make an exact copy of the original frames of the reduced video.

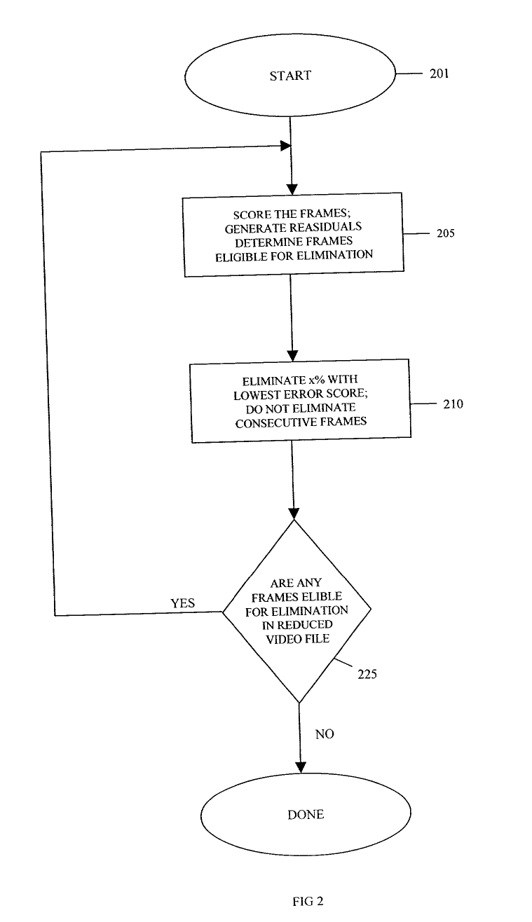

The flow chart of FIG. 2 shows the operation of the frame reduction module 112 in the preprocessor 110. The operation starts in step 201 as the video is passed to the score-the-frames routine 205. In the preferred embodiment, each frame is scored individually by determining the error caused by eliminating the frame. Alternatively, the effects of deleting multiple adjacent frames could be scored preliminary to eliminating multiple frames. In addition to scoring the frames, the routine 205 also generates the residuals. The routine 205 also determines for each video frame whether the amount of data in residuals for such frame, after compression, is greater than the amount of data in such video frame after compression. After the frames are given scores, a percentage of the frames are removed based on the given scores in routine 210. Since the scores were given without consideration of elimination of multiple sequential frames, routine 210 avoids eliminating frames that are adjacent to other frames eliminated in this pass through routine 210. The percentage of frames to be removed in one pass through routine 210 is adjustable, but is set at 10% in the preferred embodiment. In the elimination process, only frames which are determined to be eligible for elimination are eliminated. An eligible frame is one for which the amount of data in the residuals for such video frame, after compression, is less than the amount of data in such video frame after compression. After completing routine 210, the program enters decision sequence 225 to determine whether or not the frame reduction process has been completed. If the frame reduction process has not been completed, the reduced video file is passed back through routines 205 and 210 to again reduce it by selecting additional eligible frames for elimination. In the last cycle through the routines 205 and 210 less than 10% of the remaining frames may be eligible for elimination, in which the case the last cycle, in eliminating only the eligible frames, will eliminate less than 10% of the frames in the remaining reduced video. It is possible that the frame elimination will continue until there are only two frames left, which would be the first frame and the last frame of the video.

In decision sequence 225 the program determines whether or not the frame elimination process has been completed by determining whether or not there are any more eligible frames in the remaining reduced video. If any eligible frames are remaining, the process will cycle through the routines 205 and 210. If no eligible frames remain in the reduced video, the frame elimination process is completed. When the process of eliminating frames reaches the point at which no eligible frames remain in the reduced file, the next frames to be selected according to their score would each have residuals which are of greater size than the data in their frames. This corresponds to the condition where the elimination of a frame increases the size of the compressed residuals by more than the size of the compressed data of the frame to be eliminated.

In the above described process, only frames for which the residuals are of lesser size in the amount of data than the corresponding video frames are eliminated. The process eliminates the precise number of frames to achieve the maximum data reduction. Then the frame elimination process is stopped. Alternatively, the point at which the frame elimination stops may be estimated and the determination may be made in a way in which the stopping point only approximates the exact point at which the maximum data reduction is achieved. For example, the stopping point for the frame elimination could be determined by comparing the residuals in all the frames selected for elimination in a given cycle with the data in the selected frames and when the residuals equal or exceed the data in the selected frames, stopping elimination process.

In the preferred embodiment as described above, the comparison of the amount of data in the residuals with the data in the corresponding video frames is done after the data has been compressed. Alternatively, instead of compressing the data to make the comparison, the relative sizes of the data amounts after compression can be estimated.

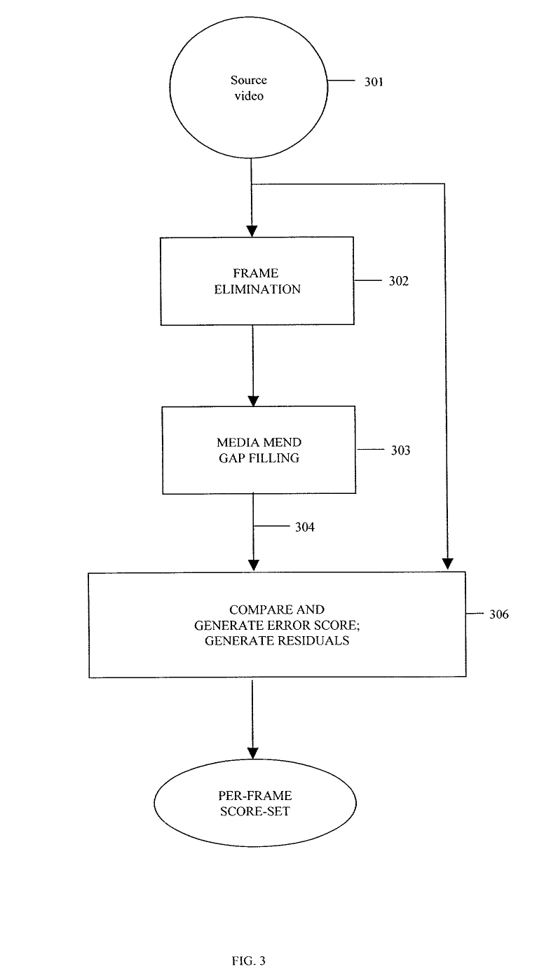

FIG. 3 shows the operation of the score-the-frame routine 205. The source video 301 is passed to a frame elimination step 302 which removes single frames. The video with the frame removed is passed to a mending routine 303 to produce a mended version 304 of the removed frame. This mended version is passed, along with the original frames 305, to a comparison module 306. This comparison module evaluates the mended frames against the original frames and gives them an error score indicating how different the mended frame is from the original. The scoring process starts by eliminating a selected frame between the first and last frames of the video, such as, for example, the second frame. Then the system mends the video by recreating the eliminated frame using a selected mending technique, such as interpolation from dense motion field vectors. The recreated frame, called the mended frame, is then compared pixel by pixel, or other method, with the original eliminated frame to provide the error score for the corresponding original frame indicating how much the mended frame differs from the original frame. This scoring process is repeated for each intermediate frame in the motion picture from the second frame to the penultimate frame. The scoring can be done using any number of heuristics. In the preferred embodiment, a least-squared difference (|A²−B²|)½ is computed on each of the color components (RGB or YUV) for each pixel, A being a color component (RGB or YUV) of a pixel in the original frame and B being the corresponding color component of the corresponding pixel in the mended frame. The total is then stored as the error score for each frame. The smaller the score, the better the match and the higher the priority of removing this frame.

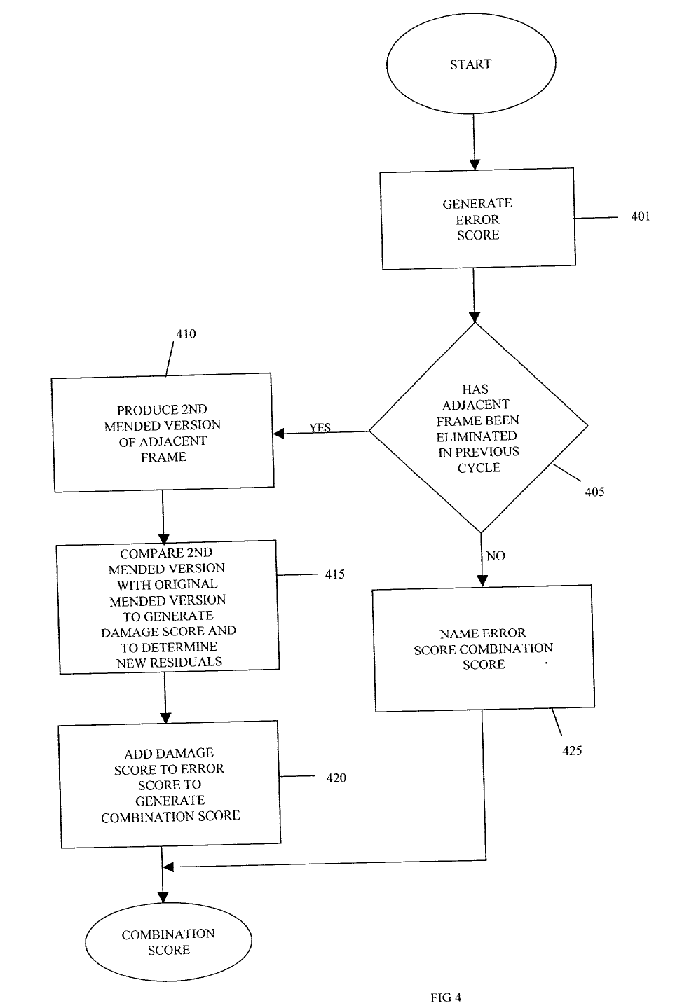

To achieve the result of eliminating frames without eliminating adjacent frames in the routine 210, the frame with the lowest error score is selected and is eliminated first. The process of routine 210 then finds the frame which has the next lowest error score and which is not next to a frame which not has been previously eliminated in this cycle through the routine 210. This process continues in this manner until the selected percentage of the frames has been eliminated. On each cycle through the routines 205 and 210, after the first cycle, the individual frames which are not adjacent to a frame which has been eliminated in a previous cycle through the routine 210 are scored in the same manner as described above for the first cycle through the routine 210. If a given frame is adjacent to a frame which has been eliminated in a previous cycle through routine 210, the given frame is given a combination score, which is its error score plus a damage score based on how much damage the elimination of the given frame will do to the mended frame or frames which will replace the adjacent, previously eliminated frame or frames. In subsequent cycles through routine 210, there may be a plurality of adjacent missing frames between the given frame being scored and the next retained original video frame in the reduced video and the damage to each of the corresponding mended frames should be measured and added to the residuals for the given frame to determine the combination score. The amount of damage to each adjacent mended frame is scored by comparing two versions of the adjacent mended frame, one version being determined by interpolation with the original given frame present and the other version being determined by interpolation with the given frame eliminated. In this latter case there will be at least two adjacent frames eliminated and the interpolation has to recreate all the missing frames from the closest frames remaining in the original video. The difference between the two versions of the mended adjacent frame is the damage score assigned to the given frame. The combination scores for the frames which are not adjacent to a frame eliminated in a previous cycle through the routine 210, are the same as the error scores for these frames. The combination scores are then compared to select and eliminate the frames which have the lowest combination scores and which are not adjacent to one another in the same manner that the frames were selected and eliminated in the first cycle through the routine 210 until the selected percentage of the frames have been eliminated. FIG. 4 is a flow chart to carry out the above described process. As shown in FIG. 4, the program first in step 401 scores the frame which is a candidate for elimination in the same manner described for the first cycle through the routine 210. The program then enters the decision sequence 405 to determine whether or not an adjacent frame has been eliminated in a previous cycle through routines 205 and 210. If an adjacent frame has been eliminated in a previous cycle, the program branches into routine 410 in which a second mended version of the previously eliminated adjacent frame is generated. In addition a second mended version is created of any other removed adjacent frames up to the next retained frame. These second mended versions are generated with the current frame being scored eliminated. Then in routine 415 the second mended version of each adjacent frame is compared with the original mended version of such adjacent frame in routine 415 to generate a damage score. Then in routine 420 the damage scores are added to the error score determined in routine 401 to determine a combination score.

If in decision sequence 405 it is determined that the frame being scored is not adjacent to a frame which has been eliminated in a previous cycle, the program proceeds from decision sequence 405 into routine 425 in which the error score generated by the routine 401 is named the combination score. In this manner as shown in the flow chart of FIG. 4 each frame between the first frame and the last frame is given a combination score which is then used to determine which frames to eliminate in routine 210 as described with reference to FIG. 2. In the subsequence cycles through routines 205 and 210 the routine 210 will eliminate a percentage of the frames with the lowest combination scores.

In accordance with the invention the scoring process saves the residuals representing the differences between the mended frames and the original frames for future usage. The differences between each pixel in the mended version of a frame and the pixels corresponding original frame are determined at the time the frames are compared in routine 306 as shown in FIG. 3.

As explained above, when a frame to be eliminated is adjacent to a frame which was previously eliminated, the mended version of the adjacent frame will be damaged and the residuals which had been computed for the previously determined adjacent frame will no longer be correct. Accordingly, new residuals are computed for each previously eliminated frame which is adjacent to a frame selected for elimination. The new set of residuals are generated by comparing the new mended version of the previously eliminated adjacent frame with the original of this frame. The determination of these residuals for damaged frames are conveniently done in routine 415 of FIG. 4.

When the frames are eliminated in routine 210, the differences between the eliminated frames and the original frames are saved as the residuals and are included in the combined file of reduced video and residuals that is stored in video storage 125. The residuals for the eliminated frames can be transmitted to the receiver along with the frames which are not eliminated. When the receiver performs the mending on the removed frames, it adds the received residual to mended versions of the frames to provide final restored frames with increased quality. The residuals may be sent whole, or may be sent selectively when the pre-processor 110 determines that the difference between the mended version and the original is noticeable. The residuals and the reduced video file are compressed before transmission using any number of common compression techniques. Preferably, the compression would be one of those that selectively uses bandwidth where the human eye is most sensitive, such as the Discrete Cosine Transform coding used by JPEG.

In the system as described above, the preprocessor will continue eliminating frames and generating residuals until the point is reached at which further frame elimination, because of the residuals required, would increase the amount of data to be transmitted or stored. At this point the frame elimination will cease. The combined file comprising the reduced video and the residuals will then be reduced the maximum amount. The combined file can then be transmitted to a receiver where the video file will be mended by interpolation and, by using the residuals, a high quality reproduction or an exact reproduction of the original video motion picture can be created. Instead of transmitting the video file to a receiver the video file may be stored for later mending by a mending processor and display. Because of the maximum reduction of data in the combined file, the storage space required to store the combined file is reduced to a minimum. This advantage makes the invention particularly useful in video motion picture cameras with solid state storage for the video data.

In the preferred embodiment as described above the process of eliminating frames continues until all of the eligible frames are eliminated. By continuing the frame elimination to this point, the greatest amount of data reduction is achieved. However it will be understood that the invention can be practiced advantageously, although imperfectly, by stopping the frame elimination process before or after this point. For example, frame elimination could be continued until the residuals for a frame selected for elimination reaches a predetermined size relative to the data in the frame selected for elimination.

The above description is of a preferred embodiment of the invention and modifications may be made thereto with departing from the spirit and scope of the invention which is defined in the appended claims.

What is claimed is:

1. A system for reducing data in a video file representing a motion picture comprising a source of digital motion pictures, a processor connected to receive and process said digital motion picture, said processor eliminating selected frames from said video to produce a reduced video and repeatedly eliminating selected frames from the remaining reduced video to progressively reduce the size of the remaining reduced video, determining residuals for each eliminated frame, said residuals for a frame representing the difference between a frame recreated from the remaining reduced video without such eliminated frame and the corresponding original video frame, said processor stopping the elimination of frames based on a measurement or estimate of the amount of the data in residuals for one or more said frames relative to the amount of data in said one or more of said frames.

2. A system as recited in claim 1 wherein said processor stops the elimination of frames when the amount of data in the residual for each of the frames in the remaining reduced video is equal to or greater than the amount of data in the corresponding frames.

3. A system as recited in claim 1 wherein said processor stops eliminating frames when a measurement or estimate of the amount of data in the residuals for the frames selected for elimination reaches a predetermined size relative to the amount of data in the corresponding frames.

4. A video system as recited in claim 1 further comprising a video data receiver, said system including a serving processor operable to transmit said reduced video and said residuals to said video data receiver.

5. A system as recited in claim 4 wherein said video data receiver includes a mending processor operable to recreate from said residuals and from the remaining reduced video the frames that have been eliminated by said first mentioned processor.

6. A system as recited in claim 5 wherein said mending processor recreates the eliminated frames from the remaining reduced video by interpolation and said first mentioned processor recreates the eliminated frames by the same interpolation process used by said mending processor.

7. A system as recited in claim 1 wherein said processor recreates from said remaining reduced video the eliminated frames by interpolation.

8. A method of reducing video data in a video motion picture comprising eliminating selected video frames from said video motion picture to produce a reduced video, repeatedly eliminating additional frames from the remaining reduced video to progressively reduce the size of the remaining reduced video, determining residuals for each eliminated frame, said residuals for a frame representing the difference between a frame recreated from the remaining reduced video without such eliminated frame and the corresponding original video frame, and stopping the elimination of frames based on a measurement or estimate of the amount of data in residuals for one or more of said frames relative to the amount of data in said one or more of said frames.

9. A method as recited in claim 8 wherein the elimination of frames is stopped when the amount of data in the residuals for each of the frames in the reduced video is equal to or greater than the amount of data in the corresponding frames.

10. A method as recited in claim 8 wherein the elimination of frames is stopped when a measurement or estimate of the amount of data in a frame or frames selected for elimination is equal to or greater than the amount of data in the corresponding frames.

11. A method as recited in claim 8 further comprising storing said remaining reduced video and said residuals for later recreation of said motion picture.

12. A method as recited in claim 8 further comprising transmitting said remaining reduced video and said residuals to a mending video processor, and recreating the eliminated frames from the residuals and from the remaining reduced video with said mending processor.

13. A method as recited in claim 12 wherein said mending processor recreates the eliminated frames from the remaining reduced video by interpolation and then adds said residuals to the corresponding recreated frames, said residuals being computed as the difference between the original frames and frames recreated by the same method of interpolation used by said mending processor.

14. A method as recited in claim 8 wherein frames are recreated from the remaining reduced video by interpolation to determine the difference between such frames and the corresponding original frames.
